(19) United States
(12) Patent Application Publication
(10) Pub. No.: US 2012/0267525 A1
(43) Pub. Date: Oct. 25, 2012

(54) GAS ANALYZER

(75) Inventors: Kohei Sasai, Otsu-shi (JP); Said Boumsellek, San Diego, CA (US)

(73) Assignee: HORIBA STEC, CO., LTD., Kyoto-shi (JP)

(21) Appl. No.: 13/092,824

(22) Filed: Apr. 22, 2011

(51) Int. Cl. H01J 49/26

(52) U.S. Cl. 250/288

(57) ABSTRACT

The present invention is directed to a gas analyzer that hardly generates noise peaks and facilitates reading of a molecular peak, even when a low-molecular-weight alkane is an analysis target. The analyzer analyzes an alkane of the carbon number 1 through 12 contained in a sample gas as an analysis target. The analyzed includes an ionization module for ionizing the sample gas by thermoelectrons having energy of 10 through 30 eV, an ion extraction electrode for extracting ions from the ionization module, a quadrupole module for selectively passing the ions extracted from the ionization module by the ion extraction electrode, through the quadrupole module, and an ion detection module for detecting the ions passed through the quadrupole module.

### TECHNICAL FIELD

The present invention relates to a gas analyzer using an EI method.

### BACKGROUND ART

Petroleum is used as energy in the form of, for example, gasoline, coal oil, or electrical power and is an extremely important resource as a feedstock of petroleum chemical products such as synthetic fibers and plastics. In a petroleum exploration, generally, a target area is first surveyed. Subsequently, a petroleum geological evaluation is executed by, for example, a literature search, a remote sensing, and an aerial photointerpretation. Also, a political and financial stability and a geographical condition are studied, and a mining right of a potentially favorable area is obtained. Then, by executing, such as, a geological/geochemical search, or a gravity/magnetic survey in the area where the mining right was obtained, a running survey is performed in order to learn an expansion of a depositional basin and a property and geological configuration outline as a source rock or a reservoir rock of a sedimentary strata. Further, an earthquake survey is performed at the potentially favorable area to collect highly accurate subsurface information. Thus acquired survey data is totally analyzed to search a site where petroleum can be collected with a high possibility. Then, an estimated amount of reserve of each site is calculated to select a site where petroleum can be collected with the highest possibility and the largest amount of reserve can be obtained as an exploratory drilling candidate site.

The petroleum drilling is performed so that mud fluid is injected into a well in order to flow out cuttings accumulated in the well to the ground above. However, upon exploratory drilling, it is important to measure gas components directly in the mud fluid within the well or the mud fluid after being sampled from the well for acquiring underground information. Especially, the measurement of a low-molecular-weight alkane in real time is valid for determining the presence or absence of the petroleum. In order to determine a pressure of the mud fluid to be injected into the well, monitoring of a methane concentration is remarkably important. This is because the bottom of the well collapses if the methane concentration is too low, whereas the bottom of the well explodes if the methane concentration is too high. Therefore, the methane concentration is required to be measured frequently in real time to adjust the pressure of the mud fluid.

Conventionally, in order to analyze the gas components in the mud fluid at the petroleum drilling site, a gas chromatography-mass spectrometer (GC/MS) has been used. However, the GC/MS is bulky, has an intricate configuration, is expensive, and requires time to extract a sample from a chromatographic column. Consequently, for being installed at the drilling site and analyzing the gas components in the mud fluid in real time, a compact and portable analyzer capable of being used on a mud logging rig is suitable. A known example of such a compact portable analyzer includes a quadrupole mass analyzing type gas analyzer using the EI method (Electron Ionization) (Patent Document 1).

### RELATED ART DOCUMENT

### Patent Document

Patent Document 1 WO2007/111110A1

### SUMMARY OF THE INVENTION

### Problems to be Solved by the Invention

However, the inventors have studied to find that, when a sample gas containing a low-molecular-weight alkane is ionized by using the quadrupole mass analyzing type gas analyzer, if thermoelectrons accelerated up to 70 eV or 43 eV as a standard ionization energy are brought into a collision with the gas, a fragment-ionization occurs because the ionization energy is too high, resulting in resolution of the low-molecular-weight alkane to be fragmented or to be a multi-charged ion charged to be a divalent or higher ion. As described above, if the low-molecular-weight alkane is resolved to be fragmented or to be the multi-charged ion, a plurality of fragment peaks as many noises are generated in thus obtained mass spectrum in addition to a target molecular peak. Thus, reading of the target molecular peak is obstructed due to the above peaks, resulting in inviting a difficulty in the analysis.

Therefore, the present invention is made for the purpose of providing a gas analyzer that hardly generates noise peaks and facilitates reading of the molecular peak, even when the low-molecular-weight alkane is the analysis target.

### Means for Solving the Problem

In other words, a gas analyzer according to the present invention is characterized in that it analyzes an alkane of a carbon number of 1 through 12 contained in a sample gas as an analysis target. The analyzer includes an ionization module for ionizing the sample gas by thermoelectrons having energy of 10 through 30 eV, an ion extraction electrode for extracting ions from the ionization module, a quadrupole module for selectively passing the ions extracted from the ionization module by the ion extraction electrode, through the quadrupole module, and an ion detection module for detecting the ions passed through the quadrupole module.

The inventors have come to complete the present invention as a result of a dedicated study such that the inventors have found that, in a case where the alkane of the carbon number of 1 through 12 is targeted to be analyzed in the quadrupole mass analyzing type gas analyzer using an EI method, if the ionization energy is set to 30 eV or below, noise peaks significantly decrease to dramatically facilitate reading of the molecular peak.

FIGS. 3 through 6 illustrate mass spectra obtained such that mixed gases of the alkanes (medium concentration (Medium) and low concentration (Low)) of which compositions are indicated in the Table 1 below are used as samples to be analyzed by the quadrupole mass analyzing type gas analyzer using the EI method, respectively.

TABLE 1

| | |
|---|---|
| Concentration | |
| (mol %) | Molecular |

| | Low | Medium | peak position (m/z) |
|---|---|---|---|
| n-pentane | 0.025 | 0.100 | 72 |
| isopentane | 0.025 | 0.100 | |
| n-butane | 0.025 | 0.250 | 58 |
| isobutane | 0.025 | 0.250 | |
| propane | 0.025 | 0.250 | 44 |
| ethane | 0.025 | 0.500 | 30 |
| methane | 0.025 | 1.000 | 16 |
| nitrogen | 99.825 | 97.550 | 28 |

As it is seen from the mass spectra illustrated in FIGS. 3 through 6, the peaks entirely decrease (or become smaller) as the ionization energy decreases from 70 eV to 30 eV. Therefore, it is assumed that the noise peaks, such as fragment peaks, decrease. On the other hand, if the ionization energy is about 30 eV, it is known that the molecular peak derived from each alkane can be satisfactorily detected even with the low-concentration (Low) sample. Consequently, regardless of the sample concentration, if the ionization energy is set to 30 eV or below, the fragment noise peaks can be decreased to facilitate the reading of the molecular peak.

Further, since an ionization potential of the alkanes of the carbon number of 1 through 12 is about 8 through 10 eV, a lower limit of the ionization energy of the alkane of the carbon number of 1 through 12 is about 10 eV. However, if a determination is made based on a state of a change (decrease) of the peaks associated with the decrease of the ionization energy from 70 eV to 30 eV, it is assumed that the molecular peak can be satisfactory read even if the ionization energy is about 10 eV.

Note that a peak observed at each of the positions 18 m/z, 32 m/z, and 40 m/z in each of the mass spectra illustrated in FIGS. 3 through 6 derives from water, oxygen, and argon, respectively. However, these are considered to be generated due to contamination of air into the samples. Further, the peak observed at 14 m/z corresponds to a fragment peak of nitrogen.

For this reason, according to the gas analyzer of the present invention, if the sample gas is ionized with the energy of between 10 and 30 eV, the alkane of the carbon number of 1 through 12 can be positive-monovalent-ionized while favorably preventing the alkane of the carbon number of 1 through 12 contained in the sample gas from being fragment-ionized or from being the multi-charged ion charged to a divalent or higher ion. As a result thereof, generation of the noise peaks on the mass spectrum can be controlled to facilitate the reading of the molecular peak corresponding to the alkane of the carbon number of 1 through 12 as the analysis target, thereby accuracy of the analysis can be enhanced.

It is so assumed that the ionization can be suitably performed by the thermoelectrons having the energy of 10 through 30 eV not only to the alkanes of the carbon number of 1 through 12 but to the other carbon hydrides such as alkene and alkyne or carbon hydrides of the number of carbons larger than 12.

In order to determine the presence or absence of the petroleum upon exploratory drilling of the petroleum, measurement of the alkanes of the carbon number of 1 through 12 in real time is effective. Accordingly, an example of the alkanes of the carbon number of 1 through 12 as the analysis target in the present invention may include the alkane contained in the mud fluid obtained from the petroleum drilling well. Note that, it is so considered that the presence or absence of the petroleum can be determined in a similar manner by measuring the alkanes of the carbon number of 1 through 8. In some cases, it is considered that the presence or absence of the petroleum can be determined only with methane, having one carbon.

In the present invention, in order to suppress the generation of the noise peaks on the mass spectrum to facilitate the reading of the molecular peak corresponding to the alkanes of the carbon number of 1 through 12 as the analysis target, it is desirable to be finely adjustable of the ionization energy within a range between 10 and 30 eV according to the analysis target. Therefore, preferably, the ionization module may be configured so that a desired value can be selected from the ionization energy at a plurality of points set within a range between 10 and 30 eV or that the ionization energy is continuously changeable within the range between 10 and 30 eV.

A method of analyzing the alkanes of the carbon number of 1 through 12 contained in the sample gas by using the quadrupole mass analyzing type gas analyzer using the EI method is also one aspect of the present invention. In other words, the analysis method according to the present invention is characterized in that it is a method of analyzing an alkane of a carbon number of 1 through 12 contained in a sample gas as an analysis target. The method uses a gas analyzer including an ionization module for ionizing the sample gas, an ion extraction electrode for extracting ions from the ionization module, a quadrupole module for selectively passing the ions extracted from the ionization module by the ion extraction electrode, through the quadrupole module, and an ion detection module for detecting the ions passed through the quadrupole module. The sample gas is ionized by thermoelectrons having energy of 10 through 30 eV.

### Effects of the Invention

As described above, according to the present invention, the generation of the noise peaks on the mass spectrum can be suppressed even when an alkane of the carbon number of 1 through 12 is used as the analysis target. Therefore, the reading of the molecular peak corresponding to the alkane of the carbon number of 1 through 12 as the analysis target can be facilitated, thereby improving the accuracy of the analysis. Accordingly, the use of the gas analyzer according to the present invention at a petroleum drilling site enables a speedy and highly accurate determination of the presence or absence of the petroleum.

### BRIEF DESCRIPTION OF THE DRAWINGS

FIG. 1 is a configuration view schematically illustrating a gas analyzer according to one embodiment of the present invention.

FIG. 2 is an internal configuration view illustrating a sensor unit in this embodiment.

FIG. 3 illustrates mass spectra obtained by a quadrupole mass analyzing type gas analyzer using an EI method provided that a mixed gas (low concentration) of alkane of the carbon number of 1 through 12 is sampled and the ionization energy is 70 eV (FIG. 3(a)) or 43 eV (FIG. 3(b)).

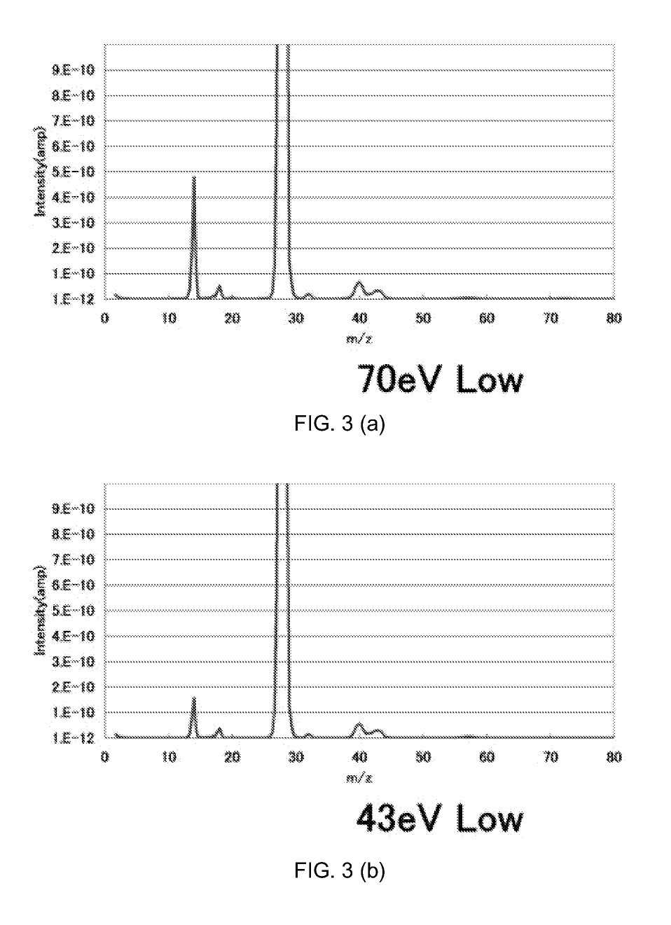

FIG. 4 illustrates mass spectra obtained by the quadrupole mass analyzing type gas analyzer using the EI method provided that the mixed gas (low concentration) of the alkane of the carbon number of 1 through 12 is sampled and the ionization energy is 40 eV (FIG. 4(c)) or 30 eV (FIG. 4(d)).

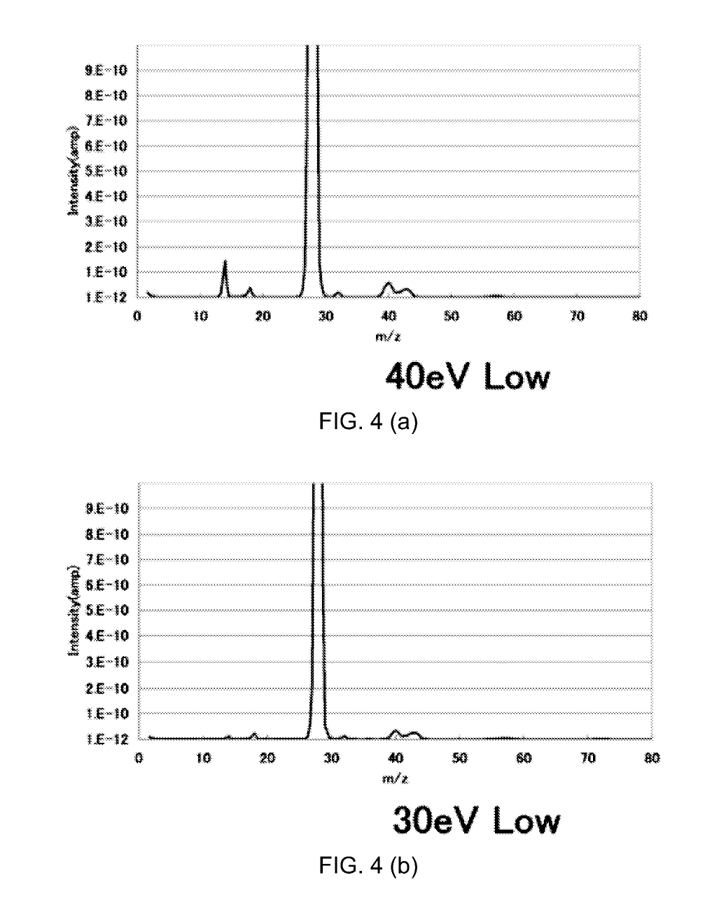

FIG. 5 illustrates mass spectra obtained by the quadrupole mass analyzing type gas analyzer using the EI method provided that a mixed gas (middle concentration) of the alkane of the carbon number of 1 through 12 is sampled and the ionization energy is 70 eV (FIG. 5(a)) or 43 eV (FIG. 5(b)).

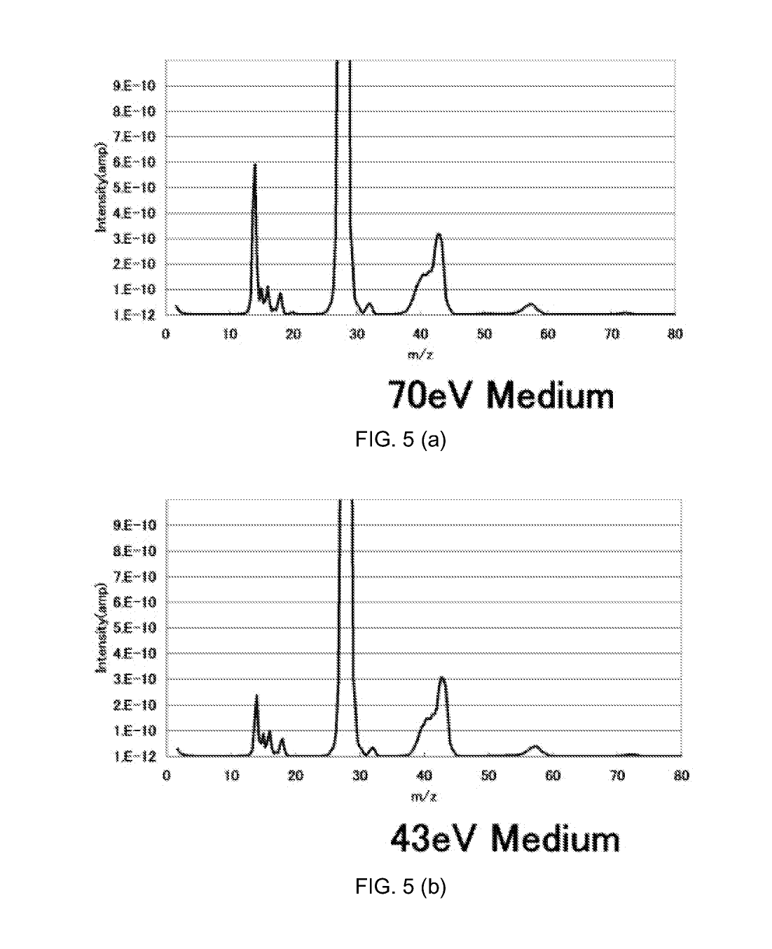

FIG. 6 illustrates mass spectra obtained by the quadrupole mass analyzing type gas analyzer using the EI method provided that the mixed gas (middle concentration) of the alkane of the carbon number of 1 through 12 is sampled and the ionization energy is 40 eV (FIG. 6(c)) or 30 eV (FIG. 6(d)).

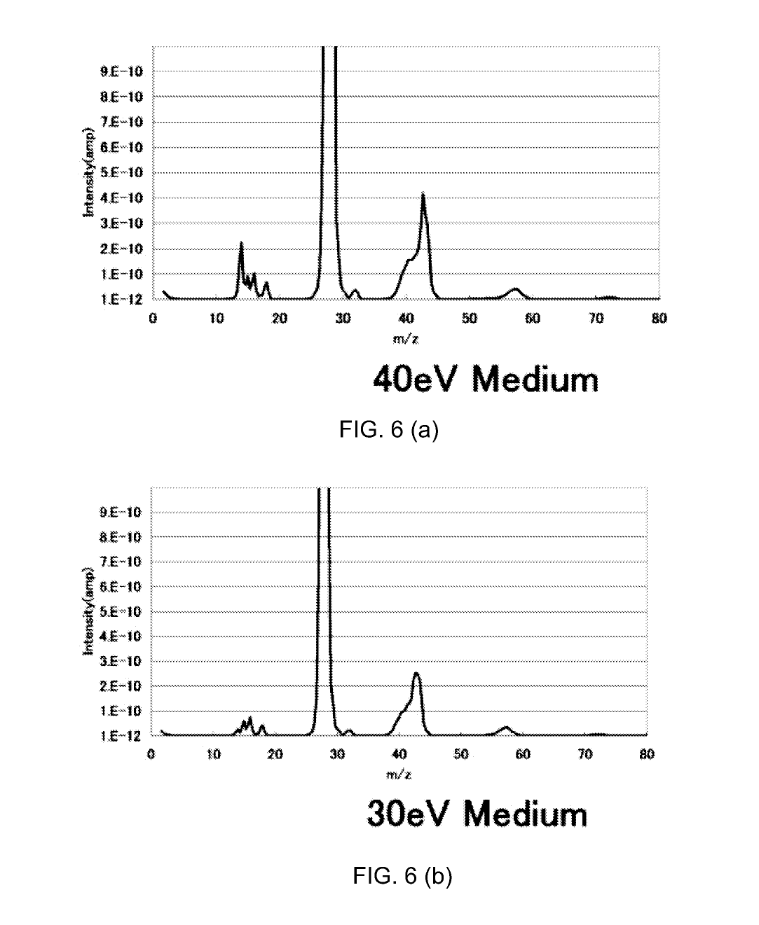

### EMBODIMENTS FOR CARRYING OUT THE INVENTION

Hereinafter, one embodiment of the present invention is described with reference to the accompanying drawings.

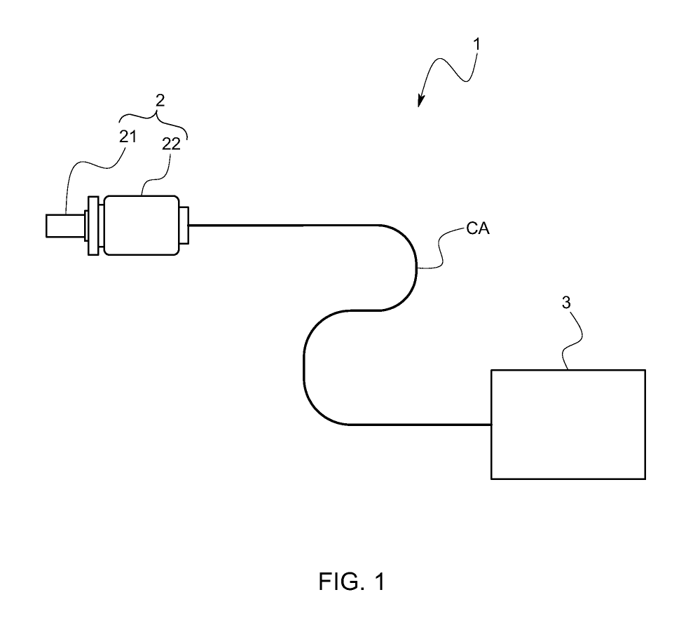

A gas analyzer 1 according to this embodiment includes, as illustrated in FIG. 1, a sensor unit 2 having a sensor section 21 for sensing a sample gas and an operating section 22 for controlling the sensor section 21 and performing, for example, analysis processing of the sample gas based on an output from the sensor section 21. The numeral “3” denotes a power source for supplying electrical power to the sensor unit 2.

Each component is described below. The sensor unit 2 includes, as illustrated in FIG. 1, the sensor section 21 and the operating section 22 that functions as an alternate current generator provided to a rear end portion of the sensor section 21.

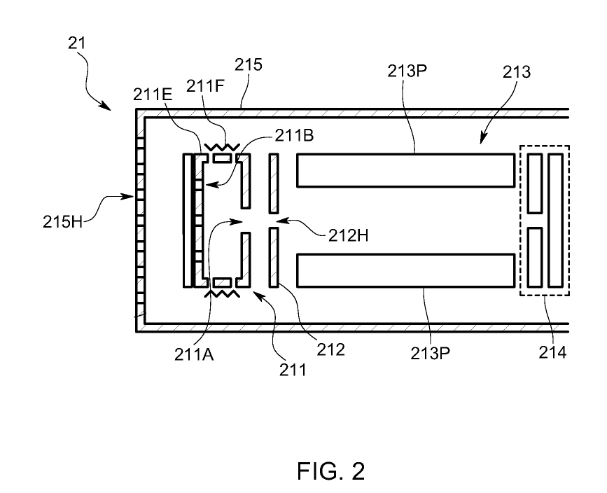

As illustrated in FIG. 2, the sensor section 21 includes an ionization module 211 for ionizing the sample gas and having an ion guide-out port 211A for guiding the ions to the outside, an ion extraction electrode 212 provided outside the ion guide-out port 211A of the ionization module 211 and for extracting the ions, a quadrupole module 213 for allowing the ions guided out of the ionization module 211 by the ion extraction electrode 212 to selectively pass through the quadrupole module 213, and an ion detection module 214 for detecting the ions passed through the quadrupole module 213.

The ionization module 211, the ion extraction electrode 212, the quadrupole module 213, and the ion detection module 214 are accommodated in a protection cover 215 in this order from a tip end side of the protection cover 215. A tip end wall of the protection cover 215 is provided with a gas guide-in port 215H for introducing the sample gas into the sensor section 21.

The ionization module 211 includes a filament 211F and a thermoelectron acceleration electrode 211E so as to accelerate the thermoelectrons discharged from the heated filament 211F up to the energy of 10 through 30 eV by an electric field generated between the filament 211F and the thermoelectron acceleration electrode 211E and thereafter ionize the sample gas introduced from a gas introduction part 211B by allowing the thermoelectrons to collide with the sample gas. The ions generated by the ionization module 211 are extracted from the ion guide-out port 211A of a substantially circular shape to the outside by the ion extraction electrode 212. Note that the ionization module 211 may be configured to be capable of selecting, as required, a desirable value from the ionization energy at a plurality of points set according to the analysis target within a range between 10 and 30 eV, or alternatively, may be configured to be capable of continuously changing the ionization energy within the range between 10 and 30 eV.

The ion extraction electrode 212 includes a single electrode or a plurality of electrodes. The ion extraction electrode 212 is arranged between the ionization module 211 and the quadrupole module 213, and it extracts the ions generated by the ionization module 211 toward the quadrupole module 213 and the ion detection module 214 and causes the ions to be accelerated and converged.

The quadrupole module 213 separates an ion beam accelerated and converged by the ion extraction electrode 212 according to a mass-to-charge ratio of the ions (mass/the number of charges (m/z)). More specifically, the quadrupole module 213 includes two pairs of counter electrodes (pole electrodes 213P) arranged at a 90° interval. A voltage that a direct current voltage U is superimposed on a high frequency voltage V cos ωt is applied between the respective sets of the counter electrode pairs shifted by 90° provided that the counter electrodes are at the same potential and wherein the V is changed so that a U/V ratio thereof becomes constant. Therefore, the ions coming into the counter electrodes are selectively passed through the counter electrodes according to the mass-to-charge ratio.

The ion detection module 214 is a Faraday cup that captures the ions separated by the quadrupole module 213 to detect them as ion current. More specifically, the ion detection module 214 detects the ions of a specific component separated by the quadrupole module 213 to further detect an absolute value of a partial pressure of the sample gas having the specific component. Further, the ion detection module 214 detects all the ions of the sample gas ionized by the ionization module 211 to further detect an absolute value of the total pressure of the sample gas.

The operating section 22 has an operation processing function and a control function and further has a function of the alternate current generator. In other words, the operating section 22 converts the ion current detected by the ion detection module 212 into a digital voltage signal indicating a voltage value, and outputs the voltage signal.

The operating section 22 includes a built-in circuit module (not illustrated) with a CPU and an internal memory and operates the CPU and peripheral devices according to program(s) stored in the internal memory. Further, the operating section 22 performs, for example, analysis processing for the sample gas based on an output of the sensor section 21.

The voltage signal outputted from the operating section 22 is transmitted to, for example, a display device (not illustrated) as measurement data and therefore a mass spectrum is displayed on a monitor of the display device with the mass-to-charge ratio (m/z) being a horizontal axis and the detection strength being a vertical axis.

The gas analyzer 1 according to this embodiment analyzes the alkane of the carbon number of 1 through 12 contained in the gas component in the mud fluid flown into the well or flown out from the well on, for example, the petroleum drilling site, as the analysis target. The gas component in the mud fluid is introduced into the sensor section 21 directly as gaseous form or with a carrier gas.

The gas component in the mud fluid introduced into the sensor section 21 is ionized in the ionization module 211 with the energy of 10 through 30 eV. At the time, if the ionization energy is less than 10 eV, it is hard to ionize the alkane of the carbon number of 1 through 12 having the ionization potential of about 8 through 10 eV, whereas, if the ionization energy is beyond 30 eV, the alkane of the carbon number of 1 through 12 is fragment-ionized or becomes a multi-charged ion charged to be a divalent or higher ion. Accordingly, many noise peaks are generated on thus obtained mass spectrum to make it hard to read the molecular peak corresponding to the alkane of the carbon number of 1 through 12 as the analysis target, thereby the accurate analysis is obstructed.

Therefore, according to the gas analyzer 1 according to this embodiment having the above configuration, ionization of the sample gas by the thermoelectrons having the energy of 10 through 30 eV enables a positive monovalent ionization of the alkane of the carbon number of 1 through 12 while favorably preventing the alkane of the carbon number of 1 through 12 contained in the sample gas from being fragment-ionized or from being the multi-charged ion charged to the divalent or higher ion. In view of the above, the generation of the noise peaks on the mass spectrum can be suppressed to facilitate the reading of the molecular peak corresponding to the alkane of the carbon number of 1 through 12 as the analysis target. As a result thereof, the accuracy of the analysis can be enhanced.

Note that, the present invention is not limited to the above described embodiment.

For example, instead of the gas analyzer 1 including the quadrupole module 213 in the above embodiment, it is so considered that the similar results can be produced by setting the ionization energy between 10 and 30 eV even if a mass spectrometry type gas analyzer, such as, a Time-of-Flight (TOF) type filter, a Magnetic Sector type filter, an Ion Trap (IT) type filter, or an Orbitrap type filter, is used as a filter portion thereof. Note that, examples of the TOF mass spectrometry (TOF-MS) type gas analyzer may include a gas analyzer including a reflectron and a Multi-turn TOF-MS type gas analyzer.

The electrons brought into the collision with the sample gas is not limited to those generated by heating of the filament 211F as far as the electrons are accelerated up to the energy of 10 through 30 eV.

Parts or all of above described embodiment and/or the modified embodiments may be combined, as required, and also it is a matter of course that various changes can be made to the embodiment without deviating from the scope of the present invention.

### DESCRIPTION OF REFERENCE NUMERALS

1 . . . Gas Analyzer
211 . . . Ionization Module
212 . . . Ion Extraction Electrode
213 . . . Quadrupole Module
214 . . . Ion Detection Module

1. A gas analyzer for analyzing an alkane of a carbon number of 1 through 12 contained in a sample gas as an analysis target, comprising:
an ionization module for ionizing the sample gas by thermoelectrons having energy of 10 through 30 eV;
an ion extraction electrode for extracting ions from the ionization module;
a quadrupole module for selectively passing the ions extracted from the ionization module by the ion extraction electrode, through the quadrupole module; and
an ion detection module for detecting the ions passed through the quadrupole module.

2. The gas analyzer of claim 1, wherein the alkane of the carbon number of 1 through 12 is contained in mud fluid obtained from a petroleum drilling well.

3. The gas analyzer of claim 1, wherein the ionization module is configured so that a desired value can be selected from ionization energy at a plurality of points set within a range between 10 and 30 eV or that the ionization energy is continuously changeable within a range between 10 and 30 eV.

4. A method of analyzing an alkane of a carbon number of 1 through 12 contained in a sample gas as an analysis target, comprising:
using a gas analyzer including an ionization module for ionizing the sample gas, an ion extraction electrode for extracting ions from the ionization module, a quadrupole module for selectively passing the ions extracted from the ionization module by the ion extraction electrode, through the quadrupole module, and an ion detection module for detecting the ions passed through the quadrupole module; and
ionizing the sample gas by thermoelectrons having energy of 10 through 30 eV.
